(19) United States
(12) Patent Application Publication
(10) Pub. No.: US 2018/0353375 A1
(43) Pub. Date: Dec. 13, 2018

(54) MATTRESS MASSAGE SYSTEM AND METHOD FOR MATTRESS MASSAGE

(71) Applicant: LOGICDATA Electronic & Software Entwicklungs GmbH, Deutschlandsberg (AT)

(72) Inventor: Haymo NIEDERKOFLER, Graz (AT)

(21) Appl. No.: 15/781,103

(22) PCT Filed: Dec. 2, 2016
(86) PCT No.: PCT/EP2016/079627

§ 371 Date: Jun. 1, 2018

(30) Foreign Application Priority Data
Dec. 4, 2015 (DE) 102015121161.0

(51) Int. Cl. A61H 23/02; A61H 1/00

(52) U.S. Cl. CPC A61H 23/0263; A61H 1/005; A61H 2023/0272; A61H 2201/1238; A61H 2201/0146; A61H 2201/1215; A61H 2201/123; A61H 2023/0281

(57) ABSTRACT

In a mattress massage system, at least one massage actuator is provided for the generation of a massaging force that acts on a mattress in a direction perpendicular to the reclining area of the mattress. The system is configured to generate the massaging force with a time-variant intensity, which comprises a fundamental frequency and at least one superposition frequency, which is higher than the fundamental frequency.

### BACKGROUND OF THE INVENTION

The present disclosure relates to a mattress massage system, in particular having an actuator for acting on a mattress. The present disclosure further relates to a method for mattress massage.

In the field of comfortable beds, massage systems having a massage actuator arranged underneath a mattress are increasingly offered. Such a massage actuator is mounted on or in the bed frame, for example. A movement that is to give the user of the bed a massage effect is generated by means of the massage actuator.

For example, vibration motors in which an unbalance mass is provided on a rotational axis are used as massage actuators, the selective uneven movement of which leads to a vibration of the assembly. This vibration is supposed to be perceived as relaxing by the user.

However, effects of conventional massage systems or massage actuators are limited, so that the massage effect is not achieved or only partially achieved.

### SUMMARY OF THE INVENTION

The present disclosure provides an improved massage concept, by means of which a more effective massage effect can be achieved.

Massage systems in the field of beds usually comprise a massage actuator acting on a mattress. The effect of the massage actuator through the mattress is transmitted to a user of the overall system, who may lie on the mattress, for example. The effectiveness of the massage to the user depends on the excitation by the massage actuator, inter alia. When operating such an electromechanical massage system, it is desirable to keep the electric power needed for the operation at a level as low as possible on the one hand, and on the other hand have the massage effect to the user as high and pleasurable as possible.

The improved massage concept is based upon the idea to configure the excitation by the massage actuator with multiple different frequencies, namely two or more oscillations or vibrations of different frequency. The individual oscillations preferably have different amplitudes and may also be configured with different phase shifts. For example, a massaging force with a time-variant intensity is generated, which has a fundamental frequency and at least one superposition frequency that is higher than the fundamental frequency. These two excitation frequencies are perceived by the user of the mattress with the massage system to be more intense, thus achieving a more efficient massage effect.

For example, excitation is composed of an oscillation with a lower fundamental frequency having a higher amplitude and a higher superposition frequency having a smaller amplitude. The generation of the oscillation respectively excitation may be performed by an integrated unit, in particular a single integrated unit. For example, a massage actuator generating the massaging force with the time-variant intensity with different excitation frequencies may be implemented as an integrated unit.

In an exemplary embodiment of a mattress massage system according to the improved massage concept, the concept comprises at least one massage actuator for generating a massaging force that acts on a mattress in a direction perpendicular to the reclining area of the mattress. The system is configured to generate the massaging force with a time-variant intensity which comprises a fundamental frequency and a superposition frequency which is higher than the fundamental frequency.

Such a mattress massage system can be integrated with a bed in a flexible and individual manner, for example by fastening on the bed frame or in a holder for the mattress of the bed. Preferably, the mattress per se is not part of the mattress massage system.

While the actual massaging force is defined by the direction perpendicular to the mattress surface and the reclining area, respectively, it is not excluded, however, that the massage actuator also generates forces that have a component acting parallel to the mattress surface. Due to the fact that the forces acting parallel to the mattress surface do not contribute or only insignificantly contribute to the massage effect, it is desirable to keep such components as low as possible. In particular, energy consumption of the massage actuator can be kept lower when generation of the parallel-acting forces is completely dispensed with or dispensed with to a greatest possible extent.

For example, the time-variant intensity of the massaging force has a first intensity component, which is determined by an oscillation at the fundamental frequency and a first amplitude, and a second intensity component, which is determined by an oscillation at a superposition frequency and a second amplitude. The first amplitude is greater than the second amplitude, for example.

For achieving the desired massage effect, it turned out to be favorable to select for the fundamental frequency a frequency range between a few tenths of Hertz and a few Hertz, namely between 0.1 Hz and 3 Hz, for example, in particular approximately 1 Hz. For the superposition frequency, frequencies between 5 Hz and 25 Hz turned out to be favorable, in particular approximately 10 Hz. However, the frequencies to be used may particularly depend on a design of the mattress. For example, firmness or thickness of the mattress may have an influence on what frequencies are to be optimally adjusted.

The mattress massage system can be designed with various types of massage actuators that for example generate the massaging force with the time-variant intensity within an integrated unit. Depending on the type pf the massage actuator, different definitions or effects may result for the intensity of the massaging force. However, the intensity of the massaging force can basically be defined by a force value and/or a local displacement of the massage actuator. In some embodiments of massage actuators, the force value and the local displacement may also have a proportional or almost proportional characteristic. For example, this is true if the massage actuator effects a local displacement into the mattress, for example by moving a plunger into the mattress. Since the mattress usually acts similarly to a spring, this results in the development of a massaging force at least approximately proportional to the displacement.

In various implementations of the mattress massage system, a linear actuator, in particular a single linear actuator is used as massage actuator, which presses a plunger from below into the mattress in a linear displacement. This is effected with the time-variant intensity course. To that end, a controller is provided, which displaces the linear actuator depending on the fundamental frequency and the superposition frequency, for example. As stated above, in each case individually defined amplitudes, which are to be regarded as displacement amplitudes here, are used for the oscillation at the fundamental frequency and for the oscillation at the superposition frequency. In general terms, the massage actuator is formed by a linear actuator for example, which is configured for transmitting the massaging force via a linearly moveable force transmitter.

In various embodiments, the intensity course with the super-positioning oscillations can be achieved with individual massage actuators formed as integrated units. However, it is also possible to effect the superposition by the use of two or more massage actuators physically arranged next to one another, so that essentially the same area of the mattress is stimulated by the mattress actuators.

In other embodiments, the massage actuator is configured to generate the transmission of the massaging force with the time-variant intensity course directly or with a single force transmission to the mattress.

The essential factor for the improved massage concept merely is that in both variants, transmission of massaging force into the mattress is effected such that it is perceived by the user as one single force with the super-positioned waveform acting on the mattress.

In various implementations, the unbalance principle is used for the massage actuator. For example, the massage actuator contains a first unbalance excitation and a second unbalance excitation. Here, the first unbalance excitation is configured for oscillating at the fundamental frequency and the second unbalance excitation is configured for oscillating at the superposition frequency.

When placed locally, two conventional vibration motors can be used to that end, which are adapted in terms of their intensity course in such a way that the oscillation with the superposed frequencies of fundamental frequency and superposition frequency is achieved.

In a special embodiment, however, a specific arrangement is used for at least one of the two unbalance excitations. In this case, this unbalance excitation has an arrangement with a first and a second rotational axis, which are driven at the same rotational speed in opposite directions. Here, a first unbalance mass is arranged on the first rotational axis and a second unbalance mass is arranged on the second axis rotational axis in a defined orientation to one another.

Centrifugal forces and centripetal forces develop due the rotation of the unbalance masses on the first and second rotational axis. Certain components of these forces cancel one another since the rotational axes rotate in opposite directions, while the components running perpendicular thereto accumulate. Here, it is assumed that the two unbalance masses have the same or approximately the same weight and are arranged at the same or approximately the same distance between the center of mass of the unbalance masses and the center of the rotational axis. Preferably, the two unbalance masses are adjusted in such a way that the connection lines between the center of mass and the center point of the respective rotational axis are perpendicular or essentially perpendicular to the virtual surface of the mattress. In this case, the vertical rotation forces accumulate, while the horizontal rotation forces cancel one another. As a result, a harmonic course of oscillations with a main component can be generated that depends on the orientation of the unbalance masses to one another and preferably is positioned perpendicular or almost perpendicular to the mattress surface.

The frequency of this oscillation is determined by the rotational speed of the rotational axes, while the resulting force component of the centrifugal force can be determined by the rotational speed of the rotational axes, the mass of the unbalance masses and the distance of the center of mass of the unbalance masses from the center of the axis.

The principle of the rotational axes driven in opposite directions can particularly be used in an oscillation system in which the first and the second rotational axis are supported in a platform, which comprises a force transmitter for the transmission of at least one component or part of the massaging force to the mattress and which is fastened in a housing as to allow oscillation. As a result, for example, the platform moves in the preferential direction defined by the orientation of the unbalance masses in the housing and transmits the oscillating energy as a component of the massaging force to the mattress.

According to the improved massage concept, two such oscillation arrangements can be fastened in local proximity to one another, in order to once generate oscillation at the fundamental frequency and once generate oscillation at the superposition frequency and generate in the mattress the resulting massaging force with superposed oscillations. However, it is generally also possible to use the above described massage actuator alone as well in order to realize only one oscillation of one frequency. Although superposition is omitted then, an energetically efficient massage actuator can nevertheless be implemented.

According to the improved massage concept, for example the first unbalance excitation comprises the arrangement with the first and the second axis of rotation, and the second unbalance excitation comprises another arrangement with a third and a fourth axis of rotation, which are driven parallel and at the same speed in opposite directions. Similar to the above described arrangement, a third unbalance mass is arranged on the third rotational axis and a fourth unbalance mass is arranged on the fourth rotational axis in a defined orientation to one another. The rotational speed of the first and second rotational axis is lower than the rotational speed of the third and fourth rotational axis. Preferably, a weight of the first and second unbalance mass is greater than a weight of the third and fourth unbalance mass.

In a developed implementation, the first, the second, the third and the fourth rotational axes are supported in a common platform, which comprises a force transmitter for the transmission of the massaging force to the mattress and which is supported in a housing as to allow oscillation. As a result, the superposition of the oscillations is effected directly in the common platform. For example, in such a configuration, the first, the second, the third and the fourth rotational axes are driven by a common drive. For example, a drive axis of the drive and the rotational axes are connected to one another via gears, friction wheels, or the like, in order to transmit the drive energy. Such common platform may form an integrated unit.

Besides the above described configurations of the massage actuator, there are further options regarding configuration of the massage actuator.

For example, the massage actuator comprises a movably-supported carrier body with a guidance arranged on the carrier body. The guidance is formed in a first oscillation, which is superposed by a second oscillation. Here, the first oscillation corresponds to the fundamental frequency and the second oscillation corresponds to the superposition frequency. Furthermore, a pusher is provided, which is supported to be displaceable in a defined orientation in relation to the carrier body, the pusher comprising a guide element coupled to the guidance and being configured to transmit the massaging force.

For example, the massage actuator comprises, as the carrier body, a cylinder supported to be rotatable around a rotational axis. The guidance is arranged on a shell of the cylinder, the guidance running contiguously round the shell and being formed in the first oscillation, which is superposed by the second oscillation. Furthermore, the pusher is supported to be displaceable in a defined orientation, in particular parallel, in relation to the shell. The cylinder preferably has the shape of a circular cylinder, but may also be designed like a truncated cone, so that the shell does not run parallel to the rotational axis as in the circular cylinder, but forms a fixed angle relative to the rotational axis. In both cases, the cylinder comprises a rotational symmetry relative to the rotational axis.

If the cylinder has the design of a circular cylinder, the first and the second oscillation run parallel to the rotational axis of the shell. In the cone shape, an angle results between the oscillations of the guidance corresponding to the angle between the shell and the rotational axis.

In the arrangement described herein, the pusher which is coupled to the guidance via the guide element, is moved up and down corresponding to the formed oscillations in a rotation of the cylinder, so that the respective massaging force can be transmitted. The rotational movement of the cylinder is thus converted in a translatory movement of the pusher.

Preferably, the pusher is supported to be displaceable with a movement component that runs parallel to the rotational axis. When the pusher merely comprises the movement component parallel to the rotational axis, a high level of efficiency in the conversion of the rotational movement into the translatory movement can be achieved based upon the assumption that the rotational axis is located perpendicular or essentially perpendicular to the virtual mattress surface. This can particularly be achieved in circular cylindrical cylinders.

In another embodiment of the cylinder, preferably small movement components perpendicular to the rotational axis are also generated besides the movement component parallel to the rotational axis. It is also possible that the pusher is supported in a such a way that it not only forms one angle in space in relation to the rotational axis, but a second angle. In this case, so to say, the pusher is mounted on the shell in an inclined manner.

In various embodiments of the massage actuator with the moveably supported carrier body, the massage actuator comprises a plate which is supported to be displaceable with a movement component parallel to the reclining area of the mattress. The displacement per se is preferably effected via an electric drive. Accordingly, the guidance extends on or in the surface of the plate. When displacing the plate, which is assumed to be horizontal, for example, this horizontal movement is converted in a vertical movement by the coupling between guidance and guide element, the vertical movement preferably corresponding to the direction of force of the massaging force. Here, in order to achieve the desired movement direction, the pusher is supported accordingly.

In various further embodiments of the massage actuator with the moveably supported carrier body, the massage actuator comprises a plate which is supported to be rotatable around a rotational axis, which extends perpendicular or essentially perpendicular to the direction of the massaging force. Here, the guidance comprises a contiguous course and is arranged eccentrically around this rotational axis. During operation of such a massage actuator, the rotational movement of the plate or of the eccentrically formed guidance is converted into a translatory movement of the pusher. This is effected by the coupling between guidance and guide element again. As in the above-described embodiment, in order to achieve the desired movement direction, the pusher is supported accordingly.

In various embodiments, the guidance is formed by an elevation, while the guide element is formed by a counter-part at least partially enclosing the elevation or by a counter-part resting on the guidance. For example, the guidance is a guidance structure in the type of a rail or the like, protruding from the shell or the carrier body, respectively. The guide element is formed by an element that is guided on the elevation, preferably from both sides. For example, the guide element is formed by a pair of rolls that slide along on a top side and bottom side of the elevation. Thus, the pusher is forcibly guided in both directions by the shape of the guidance. However, the forced guidance may also be formed merely unilaterally.

It is also possible that the guidance is formed by a (slotted) link and that the guidance element is formed by a link block guided through the link. This essentially corresponds to a cinematic reversal of the above-described principle, so that the pusher is guided on the shell or the surface of the carrier body via the link block in the link. For example, the link is formed by a depression in the surface, which in particular does no penetrate the surface.

In various embodiments having the cylinder as a carrier body, a further pusher can be provided in the massage actuator besides the first pusher, which is also supported to be displaceable parallel to the shell and comprises another guide element coupled to the guidance. Generally, additional pushers can be provided in all embodiments with carrier body, guidance and pusher coupled thereto.

Due to the fact that the additional pusher is mounted in another place of the guidance than the first pusher, usually a phase shift results for the second pusher in relation to the first pusher, in particular in terms of the displacement thereof.

Depending on the embodiment of the massage actuator, further pushers according to the proposed principle can be added also, the pushers being forcibly-guided through the guidance.

The massage effect can be further improved by the second and the further pushers.

Preferably, a link for a motor for driving the cylinder is located inside the cylinder. Here, the guidance is mounted, in particular, on the shell directed outwards. However, the reverse variant is also possible.

The improved massage concept can also be applied in a method for mattress massage, in which a massaging force is generated that acts upon a mattress in a direction perpendicular to the reclining area of the mattress. Here, the massaging force is generated with a time-variant intensity, which has a fundamental frequency and at least one superposition frequency which is higher than the fundamental frequency. As described above for the various embodiments of the system, the time-variant intensity comprises a first intensity component, which is determined by an oscillation of the fundamental frequency and a first amplitude, and a second intensity component, which is defined by an oscillation at the superposition frequency and a second amplitude.

Further embodiments of the method, in particular the ways and manner of how the massaging force with the time-variant intensity can be generated, will be apparent to a person skilled in the art from the above-described embodiments of the mattress massage system.

Although the improved massage concept and the various implementations have merely been described in conjunction with mattresses, it is possible to use them in the field of other comfortable furniture as well. For example, use in lounging furniture such as TV armchairs or massage armchairs. For example, such a system can be used in the back region of an armchair, in particular with corresponding massage actuators. The essential factor is that a massaging force is generated that comprises the described time-variant intensity.

### BRIEF DESCRIPTION OF THE DRAWINGS

The invention will hereinafter be described in greater detail by means of exemplary embodiments with reference to the drawings. Here, similar elements or elements having like functions are indicated with like reference numerals. This is why a repeated explanation of individual elements may be omitted.

The figures show in:

FIG. 1 an exemplary embodiment of a mattress massage system with a bed,

FIG. 2 a diagram of an example of a massaging force intensity plotted over time,

FIG. 3 an exemplary embodiment of a massage actuator of a mattress massage system,

FIG. 4 a schematic illustration of a possible embodiment of a massage actuator,

FIGS. 5A, 5B and 5C different views of an exemplary implementation of a massage actuator based upon FIG. 4,

FIG. 6 a schematic illustration of an exemplary embodiment of a further massage actuator,

FIGS. 7A, 7B and 7C various views of an exemplary embodiment of a further massage actuator,

FIG. 8 exemplary cross-sectional illustration of the massage actuator of FIG. 7,

FIG. 9 exemplary detailed view of a massage actuator according to FIG. 7,

FIG. 10 detail of an exemplary alternative embodiment for the massage actuator of FIG. 7,

FIG. 11 an exemplary characteristic diagram of intensities in a massage actuator of FIG. 7,

FIG. 12 a schematic illustration of an exemplary embodiment of a further massage actuator, and

FIG. 13 a schematic illustration of an exemplary embodiment of a further massage actuator.

### DETAILED DESCRIPTION

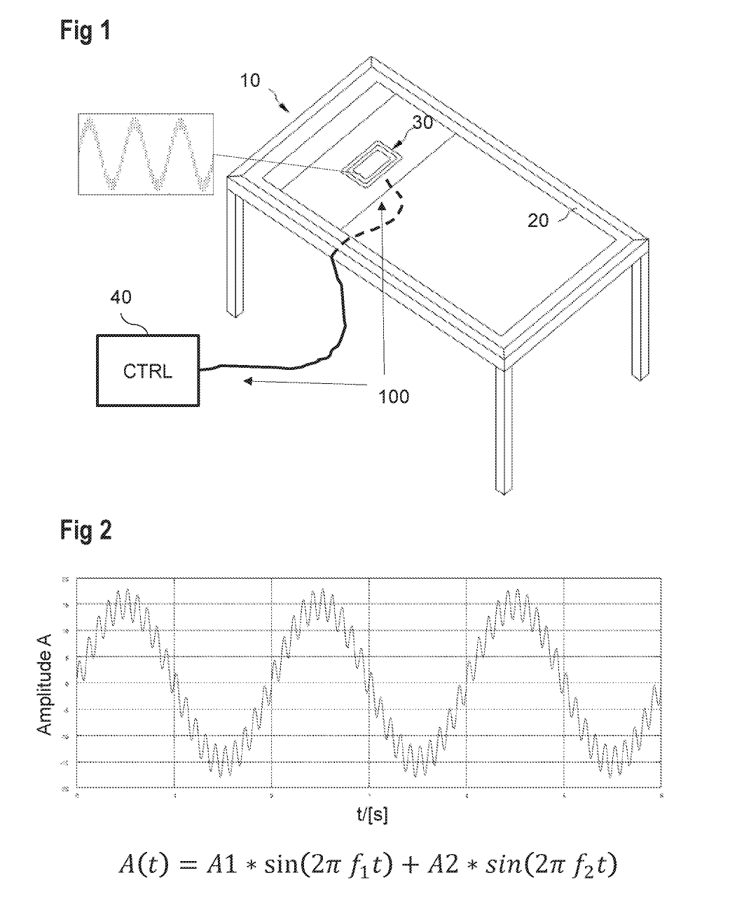

FIG. 1 shows an exemplary embodiment of a mattress massage system according to the improved massage concept in conjunction with a bed 10. In an exemplary manner, bed 10 comprises a support 20 for a mattress (not shown). Moreover, a holder for a massage actuator 30 is provided in the support 20, the actuator being connected to a massage controller 40. If, according to an intended use of a mattress, reclining on the support 20 or the massage actuator 30 is effected, a massage effect can be achieved through the mattress by a corresponding control of the massage actuator 30 by the massage controller 40. Together, the massage actuator 30 and the massage controller 40 form a mattress massage system 100. In the illustration of FIG. 1, the massage actuator 30 is merely shown in an exemplary manner and can be implemented by multiple different types of massage actuators, what will be explained hereinafter by means of some examples.

Here, the mattress system is configured to generate a massaging force via the massage actuator 30, which acts on a mattress in a direction perpendicular to the reclining area of the mattress. In the present case, this direction corresponds to the perpendicular to the base area of the support 20. According to the improved massage concept, the massaging force is generated with a time-variant intensity. This is indicated by the schematically illustrated intensity characteristic in FIG. 1.

A more precise but nevertheless exemplary illustration of the time-variant course of intensity is illustrated by way of a diagram in FIG. 2. The mattress massage system is configured to generate the massaging force with a time-variant intensity, which comprises a fundamental frequency f1 and at least one superposition frequency f2, which is higher than the fundamental frequency. As can be seen from FIG. 2, the time-variant intensity comprises a first intensity component, which is determined by an oscillation at the fundamental frequency f1 and a first amplitude A1, and a second intensity component, which is determined by an oscillation at the superposition frequency f2 and a second amplitude A2. The course of intensity can be described by the following formula:

A(t)=A1*sin(2πf₁t)+A2*sin(2πf₂t)

By way of example, as also illustrated in FIG. 2, the first amplitude A1 is greater than the second amplitude A2. Thus, as an overall oscillation, a fundamental oscillation at a lower frequency and a greater amplitude is superposed by a superposition frequency at a higher frequency and a lower amplitude. Further super-positions on the course of intensity A(t) are possible.

Depending on the massage actuator 30 used, the intensity of the massaging force is defined at any time by a force value and/or a local displacement of the massage actuator 30.

In some embodiments of massage actuators, the force value and the local displacement also have a proportional or almost proportional characteristic. This is true, for example, if the massage actuator 30 causes a local displacement into the mattress, for example by moving a plunger into the mattress. Due to the fact that the mattress acts similarly to a spring, a massaging force at least approximately proportional to the displacement is generated.

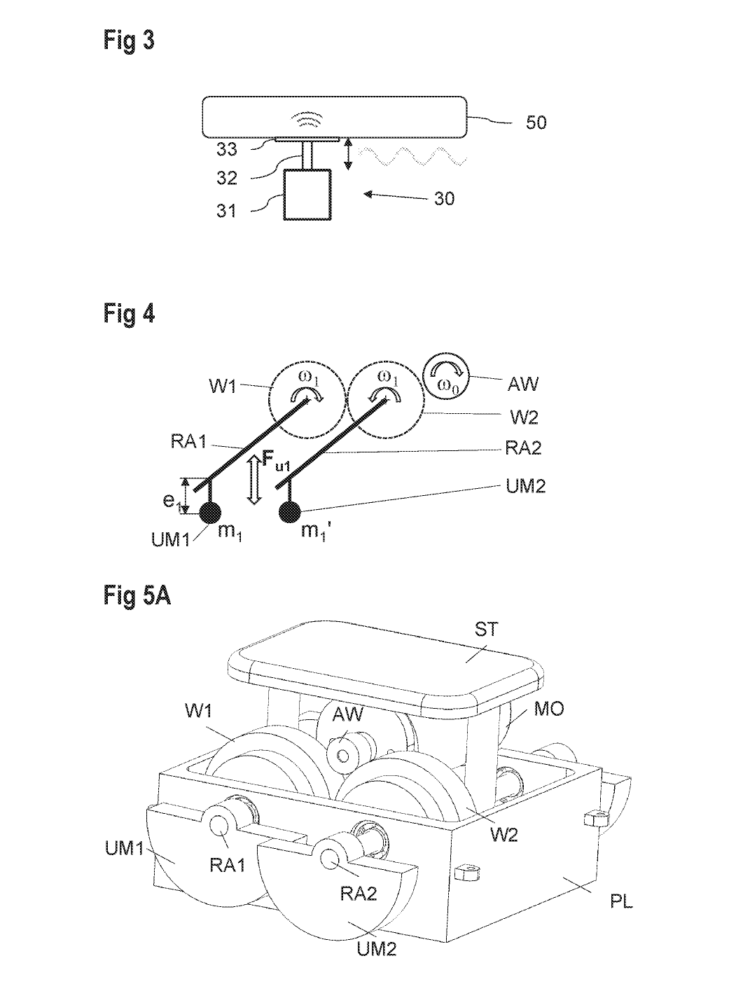

As mentioned above, the massage actuator 30 can be implemented in various configurations. For example, FIG. 3 shows a section of a mattress massage system with a mattress 50, which is stimulated by a massage actuator 30 designed as a linear actuator. The massage actuator 30 comprises a linear motor 31, a lift rod 32 and a pusher or support 33, by means of which pressure is exerted to the mattress 50. In place of the linear motor 31, other types of linear actuators can be used, for example pneumatics, hydraulics, drives with wobble disks or the like.

During operation of the mattress massage system 100, the linear motor 31 is controlled by the controller 40 (not shown here) in such a way that the time course of the displacement of the lift rod 32 or the pusher 33 comprises the superposed course of oscillation with fundamental frequency f1 and superposition frequency f2. The corresponding movement course is schematically illustrated in FIG. 3.

In another, presently not illustrated embodiment, the massage actuator is configured with two independent unbalance stimulators, one of which oscillates at the fundamental frequency f1 and the other one at the superposition frequency f2. In order to achieve the superposition and thus the desired course of intensity of the massaging force, the two unbalance stimulators are to be mounted locally as close together as possible, for example directly neighboring, underneath the mattress, in order to generate the combined massaging force in the mattress.

In known unbalance excitations, on or more unbalance masses are arranged on one axis which cause a corresponding oscillation during rotation of the axis. In such unbalance excitations, it has to be considered that movement components are generated by the rotation of the unbalance mass that are parallel to the reclining area of the mattress and thus do not actively contribute to the massage effect in the mattress.

In the operation of an electromagnetic massage system for the comfort sector, it is desirable on the one hand to keep the required electric power at a level as low as possible. On the other hand, the massage effect for the user is to be as great and pleasurable as possible. Here, the excitation of one or multiple regions underneath a mattress plays an important role. As described, the excitation can be effected with one or multiple different frequencies, amplitudes and possibly phase shifts of the individual movements amongst one another. The control of the individual entities can be effected de-centrally or alone per se.

In order to achieve this, it is proposed to drive two or more unbalance disks rotating in opposite directions by means of an electric motor. These disks form an unbalance excitation. In order to achieve the improved massage concept, the massage actuator contains, for example, a first unbalance excitation and a second unbalance excitation, wherein the first unbalance excitation is configured for oscillating at the fundamental frequency f1 and the second unbalance excitation is configured for oscillating at the superposition frequency f2.

With reference to FIG. 4, at least one of the first and second unbalance excitations comprises an arrangement with a first rotational axis RA1 and a second rotational axis RA2, which are driven parallel and at the same rotational speed ω1 in opposite directions. In particular, a drive shaft AW is provided to that end, which revolves at a drive speed ω0. By a corresponding mechanical coupling of the drive shaft AW to a first and a second shaft W1, W2, in which the rotational axes RA1, RA2, are mounted, the latter are induced to rotate. A first unbalance mass UM1 is arranged on the first rotational axis RA1, while a second unbalance mass UM2 is arranged on the second rotational axis RA2.

In the schematic illustration of FIG. 4, the unbalance masses UM1, UM2 are illustrated as point masses with weights m1, m1′, which have a defined distance e1 to the center of the rotational axes RA1, RA2. For example, the two unbalance masses UM1, UM2 are oriented in such a way that its center of mass is located underneath the rotational axes, respectively. During operation of the illustrated arrangement, the unbalance masses UM1, UM2 rotate around the axes in opposite directions, thereby producing corresponding centrifugal forces. In the illustrated orientation of the unbalance masses UM1, UM2, this results in that the horizontal components of the centrifugal forces cancel one another due to the opposite directions of the horizontal components, while the vertical components accumulate. Thus, in the optimal case, merely the vertical forces prevail, so that no or almost no energy losses develop in the unbalance excitation. To that end, weights m1, m1* preferably have the same size, at least almost the same size.

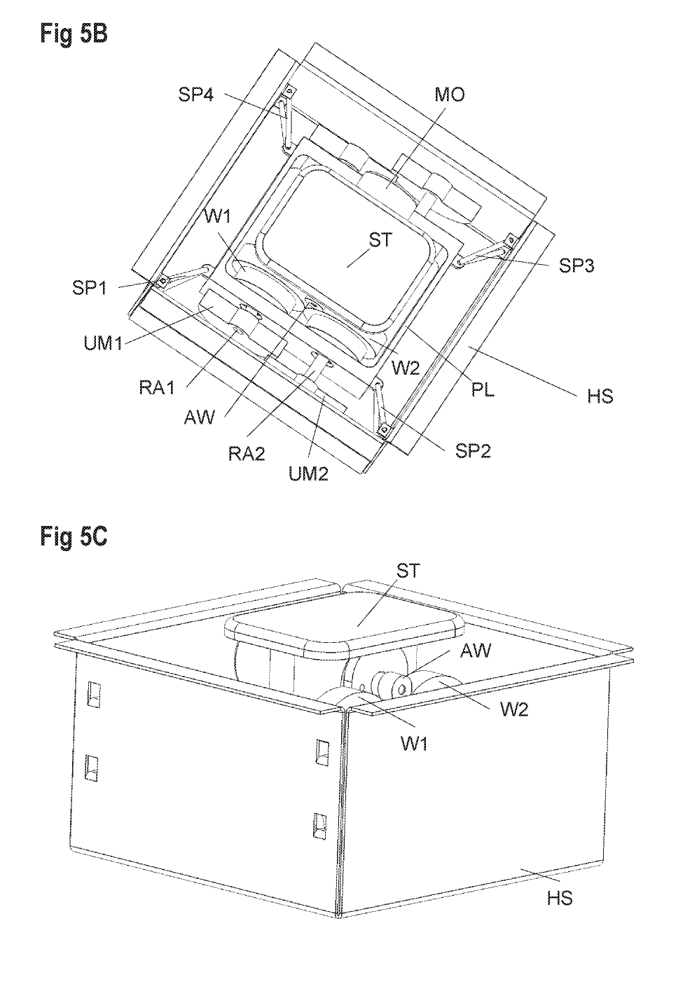

While this principle may also be used for the direct excitation, i.e. by pressing the unbalance masses to the mattress, the principle is preferably used for forming an oscillation systems based upon unbalances. Examples for that are shown in FIGS. 5A, 5B and 5C, which show different views of an unbalance excitation.

With reference to FIG. 5A, the first and the second rotational axes RA1, RA2 are supported in a first platform PL, which comprises a force transmitter ST, for example a plunger or the like for the transmission of at least one part of the component of the massaging force to the mattress. With reference to FIG. 5B and FIG. 5C, the platform PL is supported in a housing HS to allow oscillation, wherein the platform PL is mounted in the housing HS via elastic connections SP1, SP2, SP3, SP4. These are configured in the type of springs or elastic bands or the like.

As can particularly be discerned in FIG. 5A, the rotational movement generated by a drive apparatus or a motor MO is transmitted to the rotational axes RA1 and RA2 via two transmission elements or shafts W1, W2 running in opposite directions. As a result, the unbalance masses UM1, UM2 mounted on axes RA1, RA2 rotate in opposite direction to one another. By way of example, it is also illustrated here that further unbalance masses can be mounted on the other end of the rotational axes RA1, RA2 on the rotational axes RA1, RA2 in a symmetric arrangement. For example, these have an orientation corresponding to the unbalance masses UM1, UM2.

With reference to FIG. 4, the resulting force FU merely has a component in the vertical direction, since the horizontal components of the centrifugal forces cancel one another. The resulting force Fᵤ₁₄ corresponds to a harmonic oscillation at frequency F1=ω1 and, based upon the assumption of like weights m1, m1′ of the unbalance masses UM1, UM2, with the amplitude A1=2×m₁×e₁×ω₁². Finally, this leads to the fact that the platform PL oscillates in the housing HS vertically at this frequency and presses the plunger fixedly connected to the platform into the mattress according to the course of oscillation. Since, in contrast to conventional unbalance stimulators, the resulting force merely has a component in the vertical direction, the support of the arrangement can be formed in a simpler manner, since horizontal forces need not be supported. Furthermore, along with a constant massage intensity, the required energy consumption of the drive apparatus or the motor MO can be reduced.

If, in conventional unbalance stimulators, a force vector revolving at the rotary speed is generated, the bed frame is induced to oscillate in multiple directions. This may lead to an undesired development of noise. According to the described arrangement having the two unbalance masses UM1, UM2 rotating in opposite directions, this effect can be improved.

In order to achieve the superposed course of intensity according to the improved massage concept, two or multiple massage actuators of this type can be used as first and second unbalance excitations. Here, the local proximity of the two unbalance excitations is to be ensured again. However, it is generally also possible to use the massage actuator described in conjunction with FIG. 4 and FIG. 5 alone in order to realize only one oscillation of one frequency. Although superposition is omitted then, an efficient massage actuator can nevertheless be implemented.

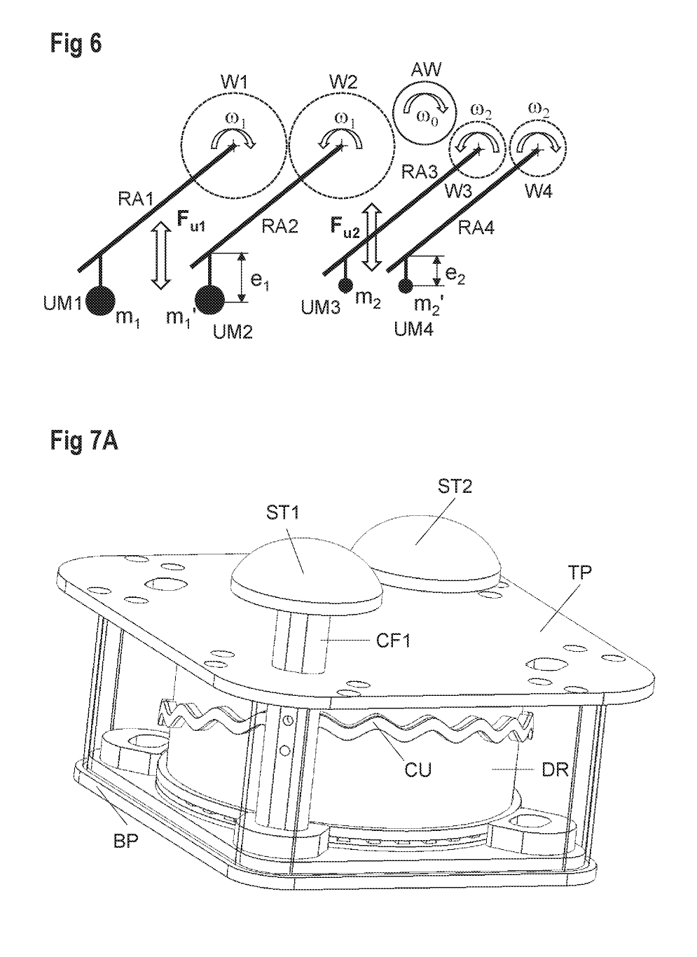

A development of the principle illustrated in FIG. 4 is shown in FIG. 6. Here, a second pair of rotary axes RA3, RA4 is provided in addition to the first and the second rotary axes RA1, RA2, which in turn are driven in opposite directions at a second rotary speed ω2. In analogy to the first two unbalance masses UM1, UM2, a third and a fourth unbalance mass UM3, UM4 are provided also on the third and fourth rotational axes RA3, RA4, which are driven by the shafts W3, W4 driven in opposite directions, the third and fourth unbalance masses illustrated as weights m2, m2′ at a distance e2 to the mass center of the rotational axes.

During operation of the arrangement, the rotational speed ω1 is lower than the rotational speed (D2 due to the predetermined sizes of the shafts W1 to W4. The rotational speed ω1 thus corresponds to the fundamental frequency f1, while the rotational speed (D2 corresponds to the superposition frequency f2. The amplitude A2 of the resulting force Fᵤ₂ can be determined in analogy to the centrifugal force Fᵤ₁, so that A2=2×m₂×e₂×ω₂² is true, wherein like weights m2, m2′ for the unbalance masses UM3, UM4 are assumed.

The course of intensity thus results from the superposition of the two centrifugal forces FU1, FU2.

In order to achieve a most compact arrangement, even the third and fourth rotational axes RA3, RA4 can be supported together with the first and second rotational axes RA1, RA2 in a common platform PL, thus forming an integrated unit. For the rest, reference is made to the illustrations in FIGS. 5A to 5C in terms of a respective implementation.

It is to be pointed out that the direction of force of the superposed forces depends on the orientation of the unbalance masses. According to the above described explanations, it is obvious to the person skilled in that art that the components of the centrifugal forces, which cancel one another, can be determined through a variation of the orientation of the masses. Further, it is pointed out that frequency ratio between fundamental frequency f1 and superposition frequency f2 can be adjusted by the ratio of the diameter or the transmission ratio of the shafts W1, W2 in relation to the shafts W3, W4. By adjusting the unbalances, the elasticity of the connections SP1 to SP4 between platform PL and housing HS, the resonance frequency of the system and thus the optimal operating point can be influenced. The transmission of the drive energy to the individual shafts can be effected by means of conventional measures such as gears, pulleys, or the like.

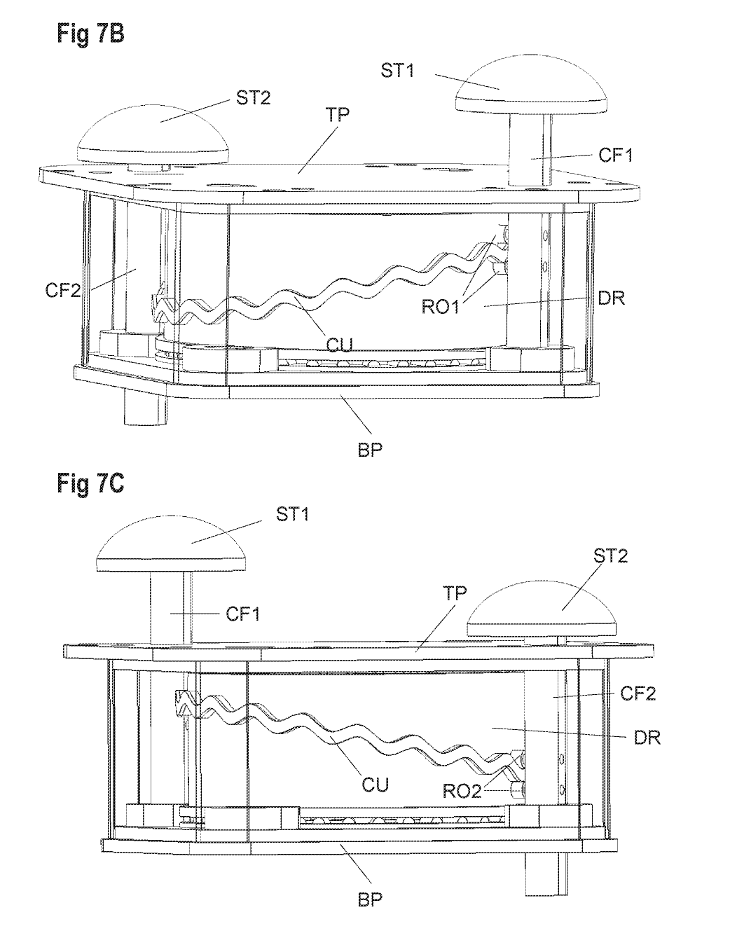

FIGS. 7A, 7B and 7C show various views of another embodiment of a massage actuator 30, which enables a realization of the improved massage concept. Such a massage actuator comprises a cylinder DR as a carrier body supported to be rotatable around a rotational axis (not discernable here). A guidance CU is arranged on a shell of the cylinder DR, the guidance running contiguously on the shell and being formed in a first oscillation, which is superposed by a second oscillation. Here, the first oscillation corresponds to the fundamental frequency f1 and the second oscillation corresponds to the superposition frequency f2. The arrangement of the massage actuator further comprises a first and a second pusher CF1, CF2, which are provided with a corresponding plunger ST1, ST2 at their respective upper end.

The first and the second pusher CF1, CF2 are supported to be displaceable in a longitudinal direction in a base plate BP and a cover plate TB of the massage actuator and guided on the guidance CU via a guide element. In the present case, the guide element is formed by a pair of rolls RO1 for the first pusher CF1 and a corresponding pair of rolls RO2 for the second pusher CF2. By the combination of guidance CU and guide element RO1, RO2, pushers CG1, CF2 are forcibly guided in accordance with the course of the guidance CU.

During operation of the massage actuator, the pushers CF1, CF2 are moved up and down according to the position of the guidance CU during rotation of the cylinder DR. Furthermore, the cover plate TP is provided to be fastened to the support 20 illustrated in FIG. 1, so that the pushers can be pressed into the mattress from below, together with the plungers ST1, ST2. For example, cylinder DR comprises corresponding means for a slide guidance on the cover plate TP or bottom plate BP at the end faces, at the top and/or at the bottom.

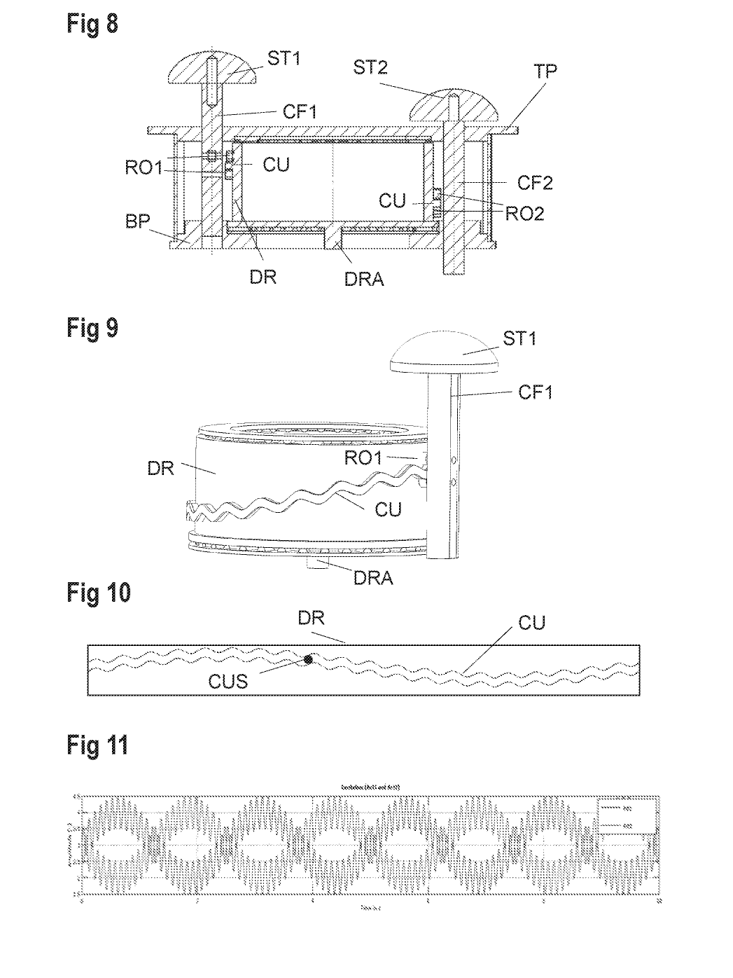

FIG. 8 shows a schematic cross-section through an arrangement according to FIG. 7, in which also the rotational axis DRA is discernable. The cylinder DR comprises a motor link, for example also on the inside, in order to ensure a drive of the cylinder. A toothing may be also be provided on the inside of the cylinder surface of the cylinder to that end.

In the illustrated embodiment, cylinder DR is formed with a circular cylinder. However, also other rotational symmetric bodies having a flat shell can be used, for example a truncated cone. The mechanic arrangement would have to be adjusted in this case—in particular, it is to be observed that the pushers are supported to be displaceable parallel to the shell.

While in each case two pushers are provided in the illustrations of FIG. 7 and FIG. 8, the described principle may also be realized with one pusher only, as illustrated in the detailed view in FIG. 9, for example.

However, it is just as well possible to provide three or four or more pushers, which are supported at the remaining corners of the essentially square base area of the massage actuator. For example, additional pushers may also be mounted on the longitudinal sides of the base area. In two or more pushers, besides the superposed course of intensity at fundamental frequency f1 and superposition frequency f2, a phase shift between the individual pushers is achieved as well. The continuous phase-shifted actuation of multiple pushers underneath the mattress gives the user of the mattress the feeling of a roll-and-knock massage. This improves the massage effect.

The guide element at the pusher, which is illustrated with the rolls RO1, RO2 by way of example, may also be replaced by another element, which at least partially encloses the guidance CU. As presently illustrated, the guidance can be formed by an elevation or another protruding guidance structure. However, the suitable interplay between guidance CU and guide element at the pusher is to be observed in any case.

In an alternative embodiment, the guidance CU is formed by a (slotted) link, as expressed by means of a rolled shell in FIG. 10, for example. In this case, the guide element per se is formed preferably by a link block CUS guided in the link, which then effects the forced guidance of the pusher in the link. For example, the link is formed by a depression or recess in the shell.

FIG. 11 shows an exemplary course of the pusher movements and thus the massaging force if the massage actuator is used for example according to FIG. 7. For example, guidance CU covers a period of the fundamental frequency f1 by one revolution.

In alternative embodiments of the massage actuator according to FIG. 7, guidance CU can also be formed with another course of oscillation. While it is basically possible to implement only the fundamental frequency without superposition, other superposition frequencies can also be co-implemented.

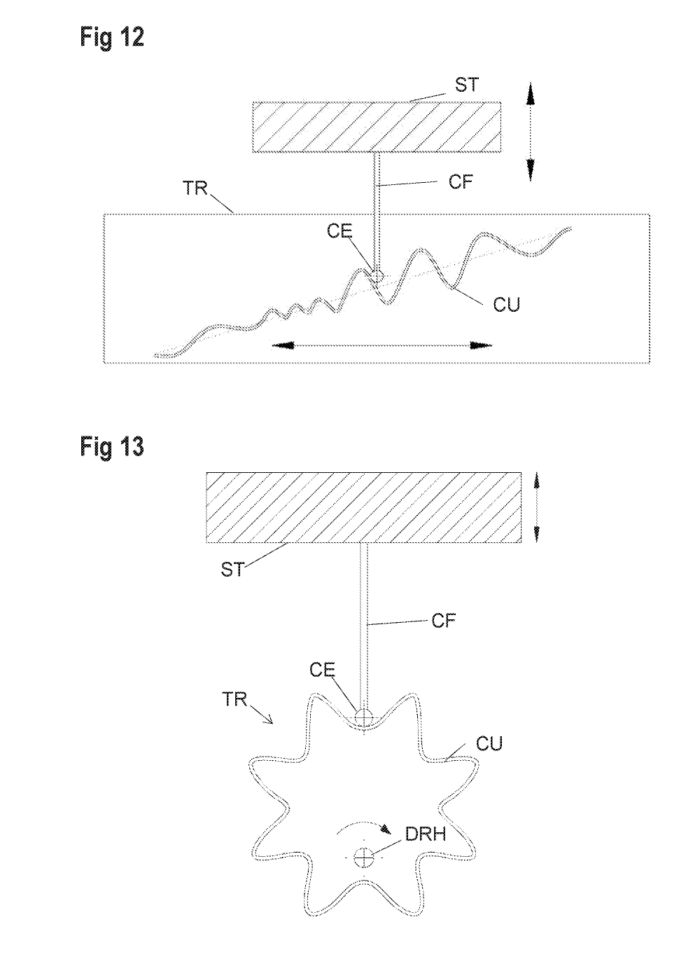

FIG. 12 shows, in a schematic illustration, another exemplary embodiment of a massage actuator, which is based upon a similar principle as the embodiments illustrated in FIG. 7. Here, a plate is provided as a carrier body TR, the guidance CU with the superposed course of oscillation attached on the plate. The carrier body TR is configured for a translatory movement, which in the present case is illustrated to be horizontal. The movement of the carrier body TR or the plate is preferably effected via an electric drive. In the illustrated arrangement, a force transmitter in the form of a plunger ST as well as a pusher CF connected thereto is further provided. At the lower end of the pusher CF, a guide element CE is mounted, which couples the pusher CF to the guidance CU.

During operation of such a massage actuator, the horizontal movement of the carrier body TR or of the plate is converted into a vertical movement of the pusher CF. To that end, corresponding bearing elements (not shown) are provided, which guide the movement into the desired direction for the generation of the massaging force.

The coupling between the pusher CF with the guidance CU via the guide element CE can be effected analogously to the described embodiments having the rotating cylinder.

FIG. 13 shows a schematic illustration of another exemplary embodiment of a massage actuator, which is based upon a similar principle as the embodiments illustrated in FIG. 7 or FIG. 12. Here, the carrier body TR is provided as a plate, which is supported to be rotatable around a rotational axis DRH. In the illustrated embodiment, the shape of the plate simultaneously corresponds to the guidance CU enclosing the plate. The plate as a carrier body T is supported to be eccentrically rotatable round a rotational axis DRH. This results in the superposition of oscillation of the first and second oscillation having the respective frequencies.

Similar to the embodiment illustrated in FIG. 12, a force transmitter in the form of a plunger ST as well as a pusher CT connected thereto is provided. At the lower end of the pusher CF, a guide element CE is mounted, which couples the pusher CF to the guidance CU. The displacement of the force transmitter is set by the respective distance between the guide element CE and the rotational axis DRH.

During operation of the arrangement, namely a rotation of the carrier body TR, the oscillation defined by the guidance CU is transmitted as a translatory movement, here vertically, to the force transmitter. Again, corresponding bearing elements (not shown) are provided to that end, which guide the movement of the force transmitter in the desired direction for the generation of the massaging force.

The coupling between the pusher CF with the guidance CU via the guide element CE can be effected analogously to the described embodiments having the rotating cylinder.

In a modification of the embodiment illustrated in FIG. 13, the plate may also have any other shape, on which the guidance CU is mounted, e.g. as an elevation or link recess. However, the illustrated principle prevails in that the form of the guidance CU is arranged eccentrically to the rotational axis DRH of the plate.

Further, additional pushers can generally be provided in all embodiments having carrier body, guidance and pusher coupled thereto, in particular also in the embodiments according to FIG. 12 and FIG. 13.

Generally, it is also possible that the guidance described in conjunction with FIGS. 7 to 13 is formed with only one oscillation, i.e. in particular without superposition of oscillations. The excitation is effected merely with the fundamental frequency in this case. The design of the guidance can be taken directly from the above described explanations by a person skilled in the art. Such a design may be advantageous, for example, when using the described cylinder DR.

Thus, with the above described arrangements, a mattress massage can be performed, in which a massaging force is generated, which acts upon a mattress in a direction perpendicular to the reclining area of the mattress. As described above, the massaging force with the time-variant intensity can be generated, which comprises the fundamental frequency f1 and at least one superposition frequency f2, which is higher than the fundamental frequency f1. In various embodiments, even further frequencies can be superposed based upon the above described principle, in order to be able to make the massage effect more pleasurable to the user.

1. A mattress massage system comprising at least one massage actuator for the generation of a massaging force which acts on a mattress in a direction perpendicular to the reclining area of the mattress, wherein the system is configured to generate the massaging force with a time-variant intensity, which has a fundamental frequency and at least one superposition frequency that is higher than the fundamental frequency.

2. The mattress massage system according to claim 1, wherein the at least one massage actuator is formed as an integrated unit that generates the massaging force with the time-variant intensity.

3. The mattress massage system according to claim 1, wherein the at least one massage actuator is configured to generate the transmission of the massaging force with the time-variant intensity course directly or with a single force transmission to the mattress.

4. The mattress massage system according to claim 1,
wherein the time-variant intensity comprises a first intensity component, which is determined by an oscillation at the fundamental frequency and a first amplitude, and a second intensity component, which is determined by an oscillation at the superposition frequency and a second amplitude.

5. The mattress massage system according to claim 4,
wherein the first amplitude is greater than the second amplitude.

6. The mattress massage system according to claim 1, wherein the intensity of the massaging force is defined by a force value and/or a local displacement of the massage actuator.

7. The mattress massage system according to claim 1, wherein the massage actuator is formed by a linear actuator, which is configured for the transmission of the massaging force via a linearly moveable force transmitter.

8. The mattress massage system according to claim 1, wherein the massage actuator contains a first unbalance excitation and a second unbalance excitation, wherein the first unbalance excitation is configured for oscillation at the fundamental frequency and the second unbalance excitation is configured for oscillation at the superposition frequency.

9. The mattress massage system according to claim 8, wherein at least one of the first and second unbalance excitations comprises an arrangement with a first and a second rotational axis, which are driven parallel and at the same rotational speed in opposite directions, wherein a first unbalance mass is arranged in the first rotational axis and a second unbalance mass is arranged on the second rotational axis in a defined orientation to one another.

10. The mattress massage system according to claim 9, wherein the first and the second rotational axis are supported in a platform, which comprises a force transmitter for the transmission of at least one component of the massaging force to the mattress and which is mounted in a housing as to allow oscillation.

11. The mattress massage system according to claim 9, wherein
the first unbalance excitation comprises the arrangement with the first and second rotational axis,
the second unbalance excitation comprises a further arrangement with a third and a fourth rotational axis, which are driven parallel and at the same rotational speed in opposite direction to one another,
a third unbalance mass is arranged on the third rotational axis and a fourth unbalance mass is arranged on the fourth rotational axis in a defined orientation to one another,
the rotational speed of the first and second rotational axis is lower than the rotational speed of the third and fourth rotational axis, and
a weight of the first and second unbalance mass is greater than a weight of the third and fourth unbalance mass.

12. The mattress massage system according to claim 11, wherein the first, the second, the third and the fourth rotational axis are supported in a common platform, which comprises a force transmitter for the transmission of the massaging force to the mattress and which is mounted in a housing as to allow oscillation.

13. The mattress massage system according to claim 11, wherein the first, the second, the third and the fourth rotational axis are driven by a common drive.

14. The mattress massage system according to claim 1, wherein the massage actuator comprises:
a moveably supported carrier body with a guidance arranged on the carrier body, the guidance formed in a first oscillation, which is superposed by a second oscillation, wherein the first oscillation corresponds to the fundamental frequency and the second oscillation corresponds to the superposition frequency, and
a pusher supported to be displaceable in relation to the carrier body, which comprises a guide element coupled to the guidance and is configured to transmit the massaging force.

15. The mattress massage system according to claim 1, wherein the massage actuator comprises:
a cylinder supported to be rotatable round a rotational axis,
a guidance arranged on a shell of the cylinder, which contiguously runs on the shell and is formed in a first oscillation parallel to the rotational axis, which is superposed by a second oscillation, wherein the first oscillation corresponds to the fundamental frequency and the second oscillation corresponds to the superposition frequency, and
a pusher supported to be displaceable in relation to the shell, which comprises a guide element coupled to the guidance and is configured to transmit the massaging force.

16. The mattress massage system according to claim 15, wherein the pusher is supported to be displaceable with a movement component that extends parallel to the rotational axis.

17. The mattress massage system according to one of claim 15, wherein the massage actuator comprises at least one further pusher, which is supported to be displaceable parallel to the shell and comprises another guide element coupled to the guidance.

18. The mattress massage system according to claim 14, wherein the carrier body comprises a plate, which is supported to be displaceable with a movement component parallel to the reclining area of the mattress.

19. The mattress massage system according to claim 14, wherein the carrier body comprises a plate, which is rotatably supported around a rotational axis, which extends perpendicularly or essentially perpendicularly to the direction of the massaging force, wherein the guidance comprises a contiguous course and is eccentrically arranged around the rotational axis.

20. The mattress massage system according to claim 14,
wherein the guidance is formed by an elevation and the guide element is formed by a counterpart at least partially enclosing the elevation or by a counterpart resting on the guidance, or
wherein the guidance is formed by a link and the guidance element is formed by a link block guided through the link.

21. A method for mattress massage, wherein a massaging force is generated that acts on a mattress in a direction perpendicular to the reclining area of the mattress, wherein the massaging force is generated with a time-variant intensity, which comprises a fundamental frequency and at least one superposition frequency, which is higher than the fundamental frequency.

22. The method according to claim 21,
wherein the massaging force with the time-variant intensity is generated with an integrated unit, in particular with a massage actuator formed as an integrated unit.

23. The method according to claim 21,
wherein the transmission of the massaging force with the time-variant intensity is generated directly or with a single force transmission to the mattress.

24. The method according to one of claim 21,
wherein the time-variant intensity comprises a first intensity component, which is determined by an oscillation at the fundamental frequency and a first amplitude, and a second intensity component, which is determined by an oscillation at the superposition frequency and a second amplitude.
